(19) United States
(12) Patent Application Publication
(10) Pub. No.: US 2001/0015588 A1
(43) Pub. Date: Aug. 23, 2001

(54) Multipolar resolver with variable magnetic coupling

(75) Inventor: Jean-Francois Maestre, Djon (FR)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Parvex

(21) Appl. No.: 09/776,183

(22) Filed: Feb. 2, 2001

(30) Foreign Application Priority Data
Feb. 3, 2000 (FR) 00 01 362

(51) Int. Cl. H02K 1/06; H02K 1/22

(52) U.S. Cl. 310/217; 310/216; 310/261

(57) ABSTRACT

The resolver with variable magnetic coupling comprises a stator constituted by first and second stacks of laminations disposed coaxially around a rotor having an axis of rotation, and spaced apart along said axis. The rotor is constituted by first and second stacks of laminations spaced apart from each other along the axis of rotation of the rotor and in register with the first and second stator stacks of laminations, respectively. The first and second rotor stacks of laminations are angularly offset from each other and each couples magnetically with the stator via an outer peripheral surface that defines at least two regularly spaced-apart lobes, thus enabling a resolver to be produced that is of low cost and that provides very good accuracy.

The present invention relates to a resolver with variable magnetic coupling, the resolver comprising a stator constituted by first and second stacks of laminations disposed coaxially about a rotor having an axis of rotation, and spaced apart from each other along said axis, the rotor defining a first air gap with the first stator stack of laminations and a second air gap with the second stator stack of laminations such that the magnetic coupling of the resolver varies as a function of the angular position of the rotor.

### BACKGROUND OF THE INVENTION

Such a resolver is particularly adapted to operating in severe environments for servo-controlling a servomotor, or indeed for servo-controlling a transmission shaft of a numerically controlled machine tool.

The advantage of this type of resolver is that it makes it possible to convert an alternating input signal into alternating output signals each of amplitude that is modulated by the angular position of the rotor. In general, this type of resolver includes one excitation circuit (input signal) and a plurality of sensor circuits (output signals). If the input signal Ve is a sinewave and of the form Ve=V.sin(ω.t), where V designates the amplitude of the signal, ω its angular frequency, and t time, then for a resolver which delivers two output signals, the output signals Vs1 and Vs2 can be modelled by the following expressions:

Vs1=k.V.sin(ω.t+d).sin(P)

Vs2=k.V.sin(ω.t+d).cos(P)

where k is a constant amplification factor, d is a constant phase shift, and P is the angular position of the rotor.

By analyzing these signals with a demodulator, it is possible to determine the looked-for angular position P.

One such resolver is described in European patent application EP 0 0 174 290. That known resolver mainly comprises a stator having one exciter coil and a plurality of sensor coils, and a rotor of a special shape providing mechanical coupling with the stator that is characteristic of the angular position of said rotor. More particularly, the stator of that resolver has two identical lamination stacks spaced apart along the axis of rotation of the rotor with the exciter coil being disposed between them, being wound around the axis of rotation of the rotor. The stator is also provided with sensor coils wound around projections formed on the inside surfaces of the lamination stacks of the stator. The rotor of that resolver is constituted by a stack of laminations extending obliquely relative to the axis of rotation of the rotor and secured to a core of ferromagnetic steel so that when seen in section on a plane containing the axis of rotation and the line of greatest slope of said stack of laminations relative to the axis of rotation, its section is in the shape of a parallelogram having one end which is close to one of the stator lamination stacks and another end which is close to the other stator lamination stack. With that structure, the alternating magnetic field induced by the exciter coil is channeled by the rotor and is characteristic of the angular position thereof.

Such a resolver is not multipolar and as a result its accuracy is poor. In addition, the unusual shape of the rotor (a stack of laminations positioned obliquely relative to the axis of the rotor) contributes to increasing its cost of manufacture. Finally, the complexity of the windings implemented on the inside surface of the stator increases the cost of manufacturing the resolver and makes it difficult to provide a structure of small size.

### OBJECT AND SUMMARY OF THE INVENTION

The object of the invention is to remedy those drawbacks.

To this end, the invention provides a resolver with variable magnetic coupling, the resolver comprising a stator constituted by first and second stacks of laminations disposed coaxially about a rotor having an axis of rotation, and spaced apart from each other along said axis, the rotor defining a first air gap with the first stator stack of laminations and a second air gap with the second stator stack of laminations such that the magnetic coupling of the resolver varies as a function of the angular position of the rotor, wherein the rotor is constituted by first and second stacks of laminations spaced apart from each other along the axis of rotation of the rotor and secured to a core of ferromagnetic steel, said first and second stacks of laminations of the rotor being normal to said axis of rotation, said first and second stacks of laminations of the rotor being in register respectively with the first and second stacks of laminations of the stator, said first and second rotor stacks of laminations being angularly offset from each other and each couples magnetically with the stator via an outer peripheral surface that defines at least two regularly spaced-apart lobes.

In the resolver of the invention, the rotor is constituted by two stacks of laminations disposed in planes that are normal to the axis of rotation, thereby enabling manufacturing costs to be reduced and accuracy to be increased. It is possible to make a rotor that is multipolar (better accuracy) while still making use of a conventional method to manufacture the rotor (stacking precut laminations in planes normal to the axis of rotation).

Furthermore, resolvers with variable magnetic coupling often give rise to problems with harmonics of the magnetic field: the output signals include odd-order harmonics, so the output signals are of a waveform that is not sufficiently close to a sinewave to achieve the desired accuracy. A conventional technique for remedying that problem consists in increasing the number of sensor coils and in giving them different numbers of turns determined using a conventional technique: thus for a two-pole resolver in which the number of sensor coils is raised to 16 (each having the appropriate number of turns) it is found that the amplification factors for harmonics of orders 2 to 14 are very close to zero. If the number of turns is calculated for a twofold resolver having four sensor coils, then it is found that it is not possible to attenuate harmonics. Implementing a rotor having petal-shaped lobes in accordance with the invention serves to remedy that drawback. This particular lobe profile makes it possible to obtain a resolver which significantly attenuates harmonics of orders 3 and 5, while retaining a small number only of sensor coils, all of which have the same number of turns.

In order to further optimize the accuracy of the resolver, it has been found that it is important to isolate the magnetic field produced by the resolver from disturbances that can arise in its environment. The presence of a massive Diece of metal close to the resolver tends significantly to alter the magnetic field lines produced by the resolver, and that tends to degrade its accuracy. One method of proceeding consists in sandwiching the stator between copper plates that are cut out to shapes that are identical to those of the laminations constituting the stator stacks, and that act as electromagnetic isolators. The same technique is applied to the stacks of laminations of the rotor.

Another advantage of the device of the invention is the way in which the sensor coils are manufactured which consists in winding the coils on winding formers and subsequently in engaging said formers on the teeth of the stator. This method of manufacture is suitable for mass production of the coils and contributes to simplifying both assembly and maintenance of the resolver.

### BRIEF DESCRIPTION OF THE DRAWINGS

An embodiment of a resolver of the invention is described in greater detail below and is shown in the accompanying drawings.

FIG. 1 is a diagram of the main elements of the resolver of the invention for the special case of a resolver having ten poles.

FIG. 2 shows the magnetic field lines seen in a plane containing the axis of rotation, and it also shows the disposition of the copper sheets.

FIG. 3 gives the envelope curves of output signals from a rotor having eight poles of conventional profile.

FIG. 4 gives the envelope curves of output signals from a rotor having eight poles of curved profile.

FIG. 5 shows an example of a conventional lobe profile (not optimized) for a ten-pole resolver.

FIG. 6 shows an example of a petal-shaped lobe profile enabling harmonics of orders 3 and 5 to be attenuated in a ten-pole resolver.

### MORE DETAILED DESCRIPTION

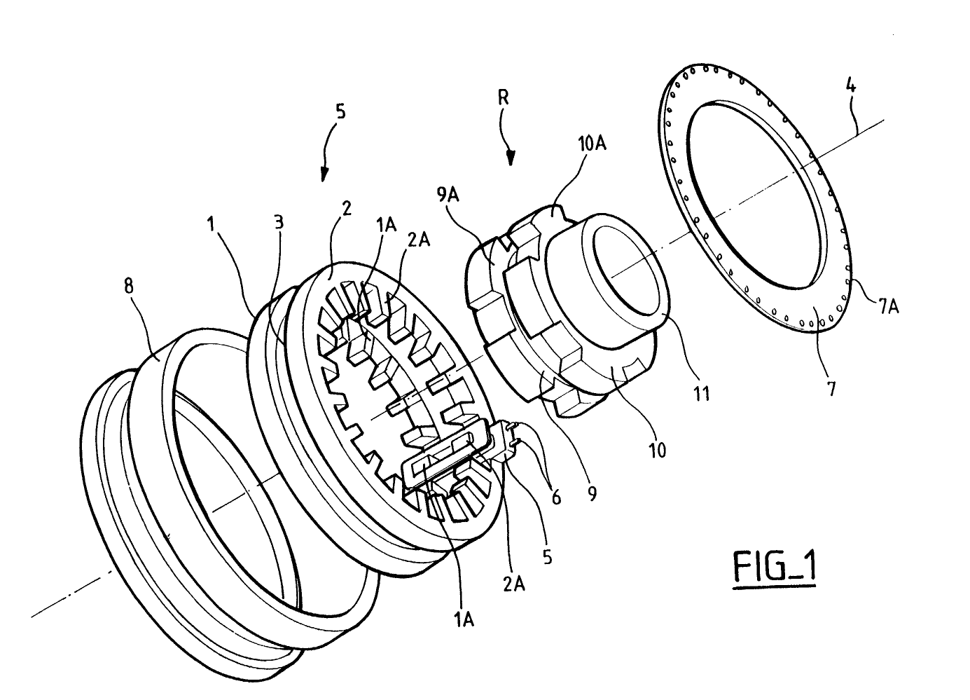

FIG. 1 is an exploded view of a resolver of the invention showing the main elements making up the stator and the rotor.

The stator S comprises a first stack of laminations 1 and a second stack of laminations 2 surrounding the rotor R and disposed coaxially about the axis of rotation 4 of the rotor. An exciter coil 3 wound around the axis of rotation 4 of the rotor R is disposed between the first and second stacks of laminations 1 and 2 of the stator.

As can be seen in FIG. 1, each stack of laminations 1, 2 of the stator couples magnetically with the rotor via an inside surface that is defined by teeth 1A, 2A extending radially towards the axis of rotation 4. The two stacks of laminations 1, 2 of the stator are in angular alignment about the axis 4. As can be seen in FIG. 1, a tooth 1A of the stack of laminations 1 is aligned in the direction of the axis 4 with a corresponding tooth 2A of the stack of laminations 2. Each sensor coil of the stator (not shown) is wound around a winding former 5 of generally toroidal shape (only one is shown in FIG. 1 so as to make it easier to understand) suitable for engaging in removable manner on a pair of teeth formed by two adjacent teeth 1A and 2A of the first and second lamination stacks 1, 2 of the stator.This structure makes it very easy to fit the sensor coils to the stator or indeed to replace them when performing maintenance on the resolver. Each winding former 5 can be made of low-cost plastics material and the exciter coils can be mass-produced in advance using a specialized coil winding machine. Each former 5 has two electrical connection pins 6 connected to the wire of the coil and designed to be plugged directly into a printed circuit 7 of annular shape which serves to interconnect the sensor coils of the stator. It will be understood that the printed circuit 7 with electrical contact holes 7A at its periphery for receiving the pins 6 is positioned coaxially about the axis 4 on one or other of the two side faces of the stator, as shown in FIG. 1.

The stator also has a toroidal yoke 8 of magnetic steel surrounding the stacks of laminations 1 and 2 and serving to channel the field lines of the magnetic filed which is generated by the exciter coil.

The rotor R is constituted by two stacks of laminations 9 and 10 that are secured to a tubular core 11 of ferromagnetic steel which channels the field lines between the two stacks of laminations 9 and 10. The stacks of laminations 9 and 10 of the rotor are coaxial about the axis 4 and spaced apart along it, being in register respectively with the stacks of laminations 1 and 2 of the stator.

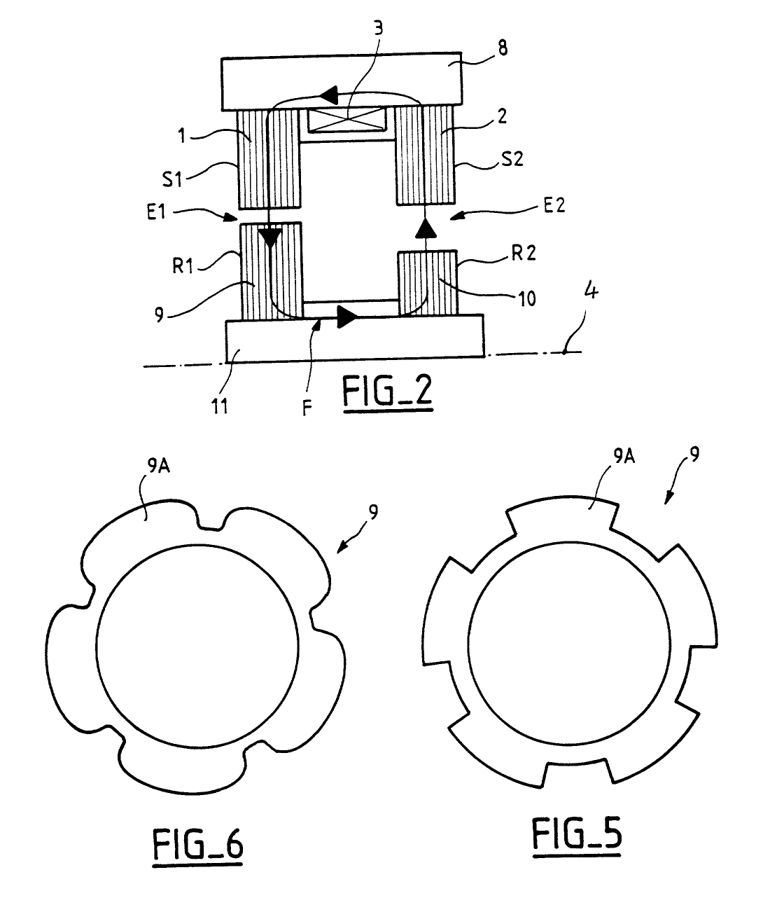

Each of the stacks of laminations 9 and 10 couples magnetically with the stator via an outer peripheral surface that defines lobes 9A, 10A that are regularly spaced apart and that are angularly offset relative to each other. This angular offset between the two stacks of laminations 9 and 10 provides an air gap which, when seen in a common plane containing the axis of rotation, is small in register with a first stack of laminations and is large in register with the other stack of laminations, as shown in FIG. 2.

FIG. 2 shows the field lines seen in section on a plane containing the axis of rotation 4. The air gap E1 which is situated between the first stator stack of laminations 1 and the first rotor stack of laminations 9 is considerably smaller than the air gap 2 which is situated between the second stator stack of laminations 2 and the second rotor stack of laminations 10. The magnetic flux passing through the sensor coil along the path F is thus of an amplitude which varies between a minimum beneath the air gap E1 and a maximum beneath the air gap E2. The sensor coil which receives flux from both air gaps sums the flux from both of them, and because of the angular offset between the two rotor stacks of laminations the total flux in the coil presents peaks that are alternately positive and negative. Beneath the following sensor coil, the configuration is inverted (at that point E1 is large and E2 small) such that the signal obtained from that coil is in phase-opposition relative to the signal obtained from the preceding coil.

This figure also shows the positions of the copper sheets S1, S2, R1, and R2 which serve to isolate the electromagnetic fields produced by the resolver from external electromagnetic disturbances. The sheets S1 and S2 are copper sheets cut out to the same shape as the sheets constituting the laminations of the stator stacks, and they are integrated in these stacks. As shown in FIG. 2, the sheet S1 is the first sheet along the axis of rotation in the first stator stack while the sheet S2 is the last sheet along the axis of rotation of the second stator stack. Similarly, the sheets R1 and R2 are respectively the first sheet of the first rotor stack of laminations and the last sheet of the second rotor stack of laminations. As for the stator, the sheets R1 and R2 are cut out to the same shape as the laminations constituting the rotor stacks of laminations. The copper sheets in this configuration occupy approximately two planes which isolate the resolver from electromagnetic disturbances due to its environment, these two planes thus being normal to the axis of rotation and situated at the two plane end faces of the resolver.

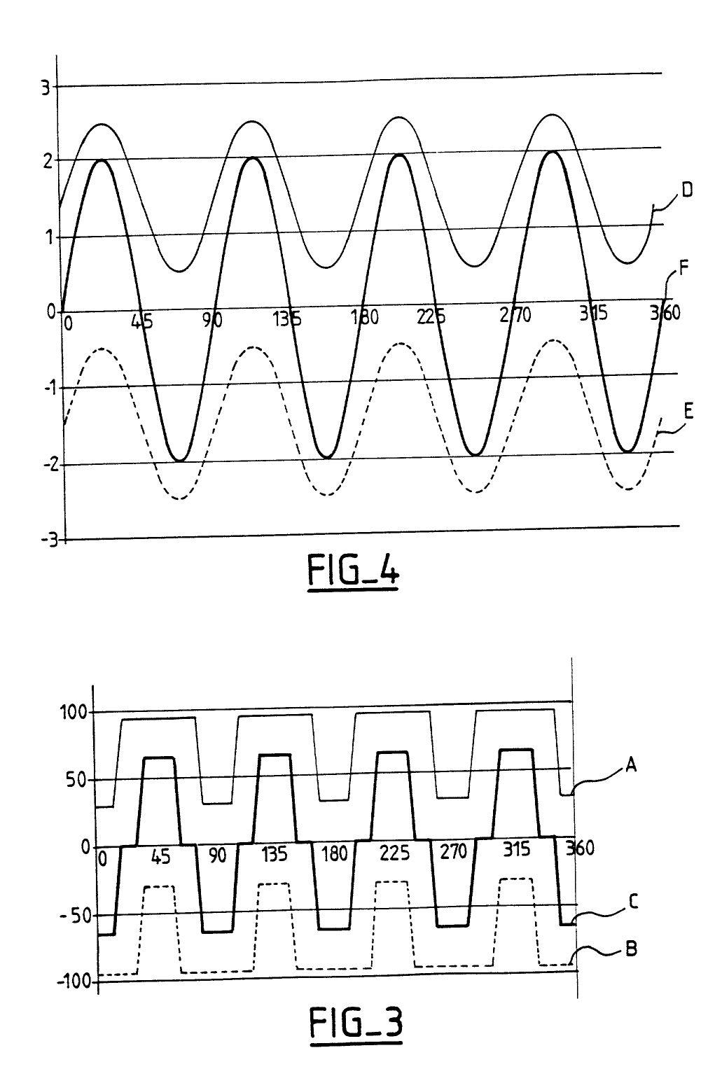

FIG. 3 gives curves showing the envelope of the flux for a rotor having lobes that are conventional (not optimized). The curves A and B give this envelope respectively for measurements performed beneath the first stator stack of laminations and beneath the second stack of laminations. Curve C gives the magnetic flux passing through the sensor coils (each surrounding one tooth of each stator stack of laminations). These curves show the influence of harmonics of orders 3 and 4: the envelope of the resulting output signal has zones (horizontal segments) in which it is not possible to locate position correctly, such that measurement accuracy cannot be considered as being satisfactory.

FIG. 4 gives the same curves respectively referenced D, E, and F for a rotor having rotor lobes each of which is in the form of an essentially curved petal. Such lobes enable the main harmonics of the flux to be attenuated so as to obtain output signals in the form of sinewaves capable of being made use of by a demodulator. As can be seen from these curves, the waveform is close enough to a sinewave to provide satisfactory reading accuracy for any angular position of the rotor.

FIG. 5 shows a first shape for lobes 9A in a conventional rotor stack of laminations. This is the shape that gives rise to the output signals shown by the curves of FIG. 3, i.e. signals in which harmonics of order 3 and 5 are not attenuated.

FIG. 6 is an example of a profile for lobes 9A in the first rotor stack of laminations that are essentially in the form of curved petals, thereby enabling harmonics to be attenuated and output signals to be obtained of the kind shown in FIG. 4. The shape of such a profile can be determined approximately using an analytic method, e.g. by requiring the permeance of the magnetic circuit to vary sinusoidally, or stepwise using software for computing by finite elements to converge on a shape which attenuates harmonics of orders 3 and 5. Naturally, the rotor stack of laminations 10 has lobes 10A which are identical in shape to the lobes 9A of the stack of laminations 9.

One way of improving the resolver is to increase the number of poles, thereby obtaining a corresponding increase in accuracy. Thus, if it is desired to make a resolver having two output signals, it is necessary for the number of sensor coils to be twice the number of poles.

In order to further improve the accuracy of the resulting resolver, it is possible to act on the angular offset between the two stacks of laminations of the rotor. If “pole angle” is defined as being the angle between two successive lobes in one stack of rotor laminations, the two stacks of laminations of the rotor can be offset by an angle that corresponds to half the pole angle, thereby constituting a basic configuration for the resolver of the invention. However, by offsetting the stacks of laminations of the rotor by an angle that is slightly different, it is possible to further improve accuracy and to attenuate harmonics of orders 3 and 5 more strongly. Good results can be obtained by offsetting the two rotor stacks of laminations by two-thirds or three-fourths of the pole angle, for example.

1. A resolver with variable magnetic coupling, the resolver comprising a stator constituted by first and second stacks of laminations disposed coaxially about a rotor having an axis of rotation, and spaced apart from each other along said axis, the rotor defining a first air gap with the first stator stack of laminations and a second air gap with the second stator stack of laminations such that the magnetic coupling of the resolver varies as a function of the angular position of the rotor, wherein the rotor is constituted by first and second stacks of laminations spaced apart from each other along the axis of rotation of the rotor and secured to a core of ferromagnetic steel, said first and second stacks of laminations of the rotor being normal to said axis of rotation, said first and second stacks of laminations of the rotor being in register respectively with the first and second stacks of laminations of the stator, said first and second rotor stacks of laminations being angularly offset from each other and each couples magnetically with the stator via an outer peripheral surface that defines at least two regularly spaced-apart lobes.

2. The resolver of claim 1, comprising at least one exciter coil, being wound around the axis of rotation of the rotor, and being disposed between the first and second stacks of laminations of the stator.

3. The resolver of claim 1, in which the lobes of the rotor are in the form of essentially curved petals.

4. The resolver of claim 1, in which each stator lamination stack has an inside surface for magnetic coupling with the rotor that defines teeth extending radially towards the axis of rotation of the rotor and wherein removable sensor coil formers of the stator are engaged respectively on pairs of teeth each formed by two adjacent teeth of the first and second lamination stacks of the stator.

5. The resolver of claim 4, in which each removable former is provided with two electrically connection pins for connection to a printed circuit serving to interconnect the sensor coils of the stator.

6. The resolver of claim 1, in which the rotor stacks of laminations are angularly offset from each other by an angle corresponding to two-thirds or three-fourths of the angle between two successive lobes in either one of the rotor stacks of laminations.

7. The resolver of claim 1, in which the first sheet along the axis of rotation of the rotor in the first rotor stack of laminations and the last sheet along the axis of rotation of the rotor in the second stator stack of laminations are copper sheets.

8. The resolver of claim 1, in which the first sheet along the axis of rotation of the rotor in the first rotor stack of laminations and the last sheet along the axis of rotation of the rotor in the second rotor stack of laminations are copper sheets.
